(19) United States
(12) Patent Application Publication
(10) Pub. No.: US 2015/0356326 A1
(43) Pub. Date: Dec. 10, 2015

(54) METHOD FOR CAPACITIVELY IDENTIFYING A CONTAINER WHICH COMPRISES AN ELECTRICALLY CONDUCTIVE MATERIAL

(71) Applicants: Jan Thiele, Chemnitz (DE); Sascha Voigt, Bernsdorf (DE); Karin Weigelt, Chemnitz (DE); Matthias Foerster, Dresden (DE)

(72) Inventors: Jan Thiele, Chemnitz (DE); Sascha Voigt, Bernsdorf (DE); Karin Weigelt, Chemnitz (DE); Matthias Foerster, Dresden (DE)

(73) Assignee: Touchpac Holdings, LLC, New York, NY (US)

(21) Appl. No.: 14/655,398

(22) PCT Filed: Dec. 27, 2013
(86) PCT No.: PCT/DE2013/000819

§ 371 Date: Jun. 25, 2015

(30) Foreign Application Priority Data
Dec. 27, 2012 (DE) 10 2012 113 105.8

(51) Int. Cl. G06K 7/08; G01N 27/22

(52) U.S. Cl. CPC G06K 7/081; G01N 27/221

(57) ABSTRACT

The invention relates to a method and system for the capacitive identification of a container which is filled with an electrically conductive liquid. In this case, a container or the content thereof is identified by capacitive coupling by a surface sensor. The invention further relates to a use of the method or system, for example for distinguishing different electrically conductive liquids.

The invention relates to a method for the capacitive identification of a container which comprises an electrically conductive material. The method comprises the steps of providing the container, providing at least one device having a capacitive surface sensor, bringing the capacitive surface sensor into contact with the container, at least one touch event on the capacitive surface sensor being triggered by capacitive coupling between the container and the surface sensor. Furthermore, the invention relates to a system for the capacitive identification of a container or the content thereof, comprising a device having a capacitive surface sensor and the container, which is characterized in that at least one touch event is triggered, preferably when there is touching contact between the container and a surface sensor. The touch event in the method and system is used for the identification of the container or the content thereof. Furthermore, the invention relates to a use of the method and/or of the system for the capacitive identification of an electrically conductive material of or in a container.

### PRIOR ART

In the prior art, capacitive information carriers are known in different embodiments. For example, a description is given of cards which are used as playing cards or collectable cards. These playing cards made of paper or paperboard have a code arrangement which can be read with the aid of a reading device. The playing cards can be interchanged amongst players and the players can compete with one another with the aid of their cards.

Furthermore, the prior art discloses gaming characters, with the aid of which a player can play games on the touchscreen. In this case, the conductivity of the bottom surface of the gaming characters is structured, so that only specific, defined subareas of the gaming character base are electrically conductive. Interpreted as a whole, these subareas yield a data code. If the gaming character is brought into contact with a touchscreen by a user, the data code can be detected and identified by a device having a touch screen.

Furthermore, the prior art comprises information carriers which are present in a form integrated into packages. In U.S. Pat. No. 5,818,019, U.S. Pat. No. 3,719,804, U.S. Pat. No. 4,587,410 and US 2006/0118612, inter alia, surface printed materials which permit secure verification or validation of data are disclosed. This can be expedient, for example for medicines and their packages but also for lottery tickets. The printed information ensures the authentication, for example, or serves for validity checking. In addition, data carriers that can be read capacitively are known, amongst others from the applications U.S. Pat. No. 3,719,804 (permanent information store) and U.S. Pat. No. 4,587,410 (parking system).

Furthermore, EP 0 569 520 or else DE 10 2008 013 509 disclose methods for printing in which conductive elements are used or printed, in order to implement information on a surface to be printed, in order in this way to individualize the materials to be printed, for example for reading devices. The products obtained with the disclosed methods can be used, for example, in logistics, in mail dispatch or in goods tracking.

Many of these information carriers are able to interact with capacitive or to some extent also resistive touchscreens, or to trigger a touch event on the same. In the following text, the term “surface sensor” is used equivalently and primarily designates capacitive surface sensors which are capable of detecting influences, for example contacts, with just this surface and in principle, to make said contacts evaluable by means of associated logic. One also speaks of capacitive interfaces, input matrices or input devices in a wider total.

Resistive or capacitive surface sensors are used to operate machines more simply. However, since the surface sensors have entered daily life, they can be used for a large number of applications and are highly significant in daily use. In order to perform an input on a capacitive monitor, which is also designated as a touch monitor, touchscreen or surface sensor, specific input pens can also be used in addition to the fingers. The capacitive, touch-sensitive monitor detects the position of the input pen, which changes the capacitive coupling between row and column electrodes. On a capacitive touch-sensitive monitor, the input is often made by the finger or fingers of a user.

As a rule, the surface sensor is accommodated in an electrical device. Such devices are, for example, smart phones, cell phones, displays, tablet PCs, tablet notebooks, touchpad devices, graphics tablets, TVs, PDAs, MP3 players, trackpads and/or capacitive input devices, without being limited thereto. Touchscreens are also known as tactile screens, surface sensors or sensor monitors. A surface sensor does not necessarily have to be located in front of a display. For example, said sensor can also be formed and used as a touchpad or the like. Furthermore, the surface sensor can be integrated in a visible or invisible manner into various devices, for example shelves.

According to the invention, what are known as multi-touch capable surface sensors are primarily of interest. Such surface sensors are able to detect a plurality of simultaneous touches and can be used, for example, in particular to rotate or scale displayed elements. This is known to the user from daily use with the smart phone. Here the surface sensor is preferably implemented as what is known as a projected-capacitive-touch technique (PCT technique). Variants of the PCT technique are, for example, “mutual capacitance” and “self capacitance”, which can be implemented as mutual-capacitance touchscreens and self-capacitance touchscreens.

In the prior art, such a surface sensor comprises in particular an active circuit, the touch controller, which is connected to a structure of electrodes. In the case of a mutual capacitance surface sensor, these electrodes are generally divided into transmitting and receiving electrodes. The touch controller preferably activates the electrodes in such a way that a signal is transmitted between respectively one or more transmitting electrodes and one or more receiving electrodes. The purpose of a surface sensor, described in the prior art, is in particular the detection of fingers or specific input devices and the position thereof on the surface of the surface sensor. To this end, the introduction of a finger, for example, has the effect that the signal between the electrodes is changed. As a rule, the signal is reduced, since the finger introduced picks up part of the signal from the transmitting electrodes and thus a lower signal arrives at the receiving electrodes.

The entry of surface sensors into daily life and the universal usability thereof is increasingly taken as a stimulus to provide new technologies which increase the usability of the surface sensors. Hitherto, information carriers which then had to be applied to objects by means of complicated methods were mostly produced. What is described in the prior art is the integration of information carriers into the object or the overprinting of the information carrier. The common feature in all these methods is that additional information carriers have to be provided and attached, which increases the number of production steps and the production costs. It is precisely when information carriers are used in conjunction with mass-produced articles that complicated production or application methods are disadvantageous since, consequently, no economic or profitable applications and products can be implemented. Furthermore, the optical-esthetic feeling of a user can be disturbed if an object is provided with an additional information carrier. Not least, the disadvantage with the prior art is that the materials normally used as information carriers are not environmentally friendly and have to be disposed of as special electronic waste.

In addition, information carriers have previously been used only in selected product groups. These include gaming cards and characters, medicines, lottery tickets, admission tickets, in the logistics sector, in mail dispatch and in goods tracking. Expanded application to a greater number of products is desirable.

On the basis of this prior art, the object of the present invention is to provide a method with which daily objects are identified capacitively by a surface sensor but do not have to be modified or have to be modified only minimally in order to be detected by the surface sensor. Consequently, such a container can be implemented not only economically but also tremendously quickly.

This object is achieved by the features of the independent claims. Preferred embodiments will be found in the sub-claims.

It was completely surprising that it is possible to provide a method with which a container which comprises an electrically conductive material can be identified capacitively. In particular, it was completely surprising that this container does not have to be modified or has to be modified only minimally in order to be detected by a surface sensor. In the ideal case, the adaptation even needs no further production steps but instead a specific selection of the existing production steps. It is therefore possible to create containers which are able to interact specifically with surface sensors without giving rise to additional investments in the sense of material, time, money or other capacities. Nothing of the sort is known from the prior art.

The method for the capacitive identification of a container which comprises an electrically conductive material comprises the following steps
a. providing the container
b. providing at least one device having a capacitive surface sensor
c. bringing the capacitive surface sensor and the container into contact
d. at least one touch event being triggered on the capacitive surface sensor by capacitive coupling between the container and the surface sensor.

The capacitive identification is implemented by a container and a surface sensor being brought into contact with each other and, as a result of approach or direct contact, a touch event occurring on the capacitive surface sensor. The term touch event is known to those skilled in the art. It is described, for example, in PCT/EP 2013/072508 or PCT/EP2012/053502.

The explanations given there in relation to the term touch event are hereby incorporated by reference in the disclosure content of the application.

Capacitive surface sensors are preferably built up from a two-layer coordinate network of electrodes, which are arranged in one layer as columns and in the other as rows. Between the electrodes there is an insulating dielectric. Attached to the underside is a circuit which continuously measures the capacitance at the crossing points of the electrodes.

A touch event in the sense of the invention is preferably the capacitive detection by a surface sensor of a contact or an approach, where the touch event can be brought about by a finger, by a container component or by a dedicated touch point provided to bring about a touch event. The technical basis for this is the capacitive coupling between the surface sensor and the overall system comprising container and the content thereof. Accordingly, a precondition that a surface sensor can detect a touch event is that a finger, a container component or a touch point is electrically conductive, in order that it can effect a change in the electrostatic field between the electrodes in a surface sensor which leads to a measurable change in the capacitance.

The container comprises an electrically conductive material which, in a preferred refinement of the invention, is selected from the group comprising a filling of the container, a material of the container and/or a constituent of an information carrier, preferably on or in the container, for example in the container closure. The filling of a container means the content thereof. In a preferred embodiment of the container, the filling is solid, gaseous or liquid. Therefore, both liquids and gases and solids are meant. The fact that the method according to the invention can be implemented with such a wide selection of filling materials was completely surprising. As a result, the method can be employed and applied in a wide range of areas of application.

The material of the container can either be electrically conductive or electrically non-conductive. In particular, any type of container can additionally be provided with a conductive covering, which is additionally applied to the container, for example after the production process.

The term information carrier is known to those skilled in the art. A preferred information carrier is known, for example, from the international application PCT/EP 2009/007578 from the applicant, the entire disclosure content of which is incorporated in the present patent application.

In a preferred embodiment of the invention, one or more information carriers can be present in a bottom, in a closure device, in a label, in a hanging label, in a package, in and/or on a side surface of a container. An information carrier can comprise, for example, one or more touch points, each touch point triggering a touch event on the surface sensor. Here, no specific connecting device is preferably used in order to connect the information carrier or carriers conductively to the container. A plurality of touch points can together yield a data code or a characteristic signature in which data can be stored.

Here, the information carrier can be present in completely or only partly electrically conductive form. This means that its surface can be configured to be completely or only partly electrically conductive. In a preferred configuration, a container can be provided with a plurality of information carriers, it being possible for these to be present both on the bottom, on the inner or outer side of a closure device, in a label, on the front or rear side thereof, in a hanging label, on the front or rear side thereof, in a package, in and/or on a side surface of a container.

The bottom side can be provided with an additional information carrier on the outer side, which usually serves as the standing surface of the container. However, it may also be preferred for the inner side of the bottom surface, which usually faces the filling of the container, to be provided with such an information carrier. It was completely surprising and represents a benefit of the invention that the method according to the invention can be used in conjunction with a multiplicity of industrial standards which, in particular ruled out the use of these materials: heavy metals and organostannic materials, bisphenol A, formaldehyde, pentachlorophenyl and phthalates. Furthermore, the method ensures compatibility with foodstuffs of all types. Therefore, the method according to the invention can also be used in the area of foodstuffs packaging, which advantageously widens the area of application of the invention.

An additional information carrier can preferably be attached to the outer side or the inner side of a closure device. A closure device in the sense of the invention is preferably a lid, a tap, a flap or a pumping device, with which the container is closed and which prevents the undesired escape of the filling from the container. In the sense of the invention, the inner side means the side of the closure device which faces the filling of the container. The outer side designates the side of the device which faces the outer surroundings.

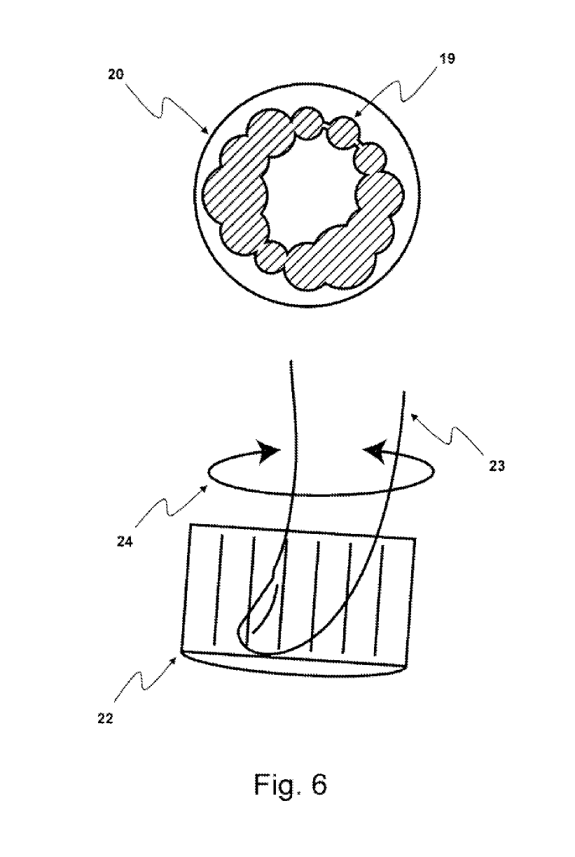

One advantage of the invention is that, for example, the lid of a container can be rotated on a surface sensor, and the data code comprising touch points that is located on the outer side of the lid or on the inner side of the lid can be read. This is implemented technically by means of touch points of different sizes, the sequence of which is detected by the surface sensor during the rotation. This rotational movement is illustrated in FIG. 6.

To this end, in a preferred refinement of the invention, the touch points are located at a defined radius about the center of a round lid, which has a preferred diameter of 28 mm, the touch points having diameters of different sizes.

An information carrier can have as many touch points as desired. However, 2 to 32 touch points on a lid are preferred. The size of the touch points varies with the number of touch points which are intended to be accommodated on the available surface. The preferred resolution with which the touch points can preferably be produced is around 0.5 mm.

The preferred method of production for the touch points and the information carriers is represented by the cold foil transfer method. However, all other printing methods which can process electrically conductive inks are conceivable. Suitable conductive inks are, for example, Eckart, 3×; PChem PFI-727; Printacarb, 3×; Acheson PF-407C. and conductive silver varnish or conductive polymers such as Pedot:PSS. Furthermore, hot embossing with aluminum-based films is advantageous. Primarily suitable for printing are screen printing and pad printing and also the film insert molding process.

An additional information carrier can also be attached in the form of a label on the container. Here, the information carrier can then be attached to the side facing the container or to the side facing the surroundings. It may be preferable for the information carrier to be present in visible or invisible form. An information carrier can be made invisible by being overprinted with a colored layer or a further material layer.

Likewise, the information carrier can be attached to the front or the rear side of a hanging label. The hanging label in the sense of this invention is, for example, a printed piece of paper or paperboard, which can be hung on a container by means of an opening or another fixing device or can otherwise be fixed. A hanging label has a high level of freedom in styling and fixing, which ensures a wide area of application.

The preferred container which is identified in the method according to the invention is selected from the group comprising bottles, cans, beverage cups or beverage cartons. A bottle in the sense of the invention is a closable container for the transport and storage of liquids. It normally consists of glass or plastic but can also consist of ceramic or metal. Bottles in the sense of the invention are in particular beer bottles, wine bottles, spirits bottles, milk bottles or bottles for milk products, such as cream or yoghurt, laboratory and medication bottles, beverage bottles, glass containers for baby food or bottled fruit or vegetables, without being restricted to this selection. In particular, both disposable and multi-use bottles can be identified by the preferred method.

Glass bottles have properties such as good product protection and the possibility of recycling. Security against breakage can be increased many times by means of optimized shapes, which are known to those skilled in the art. Special glass bottles bear on the lower rim or on the bottom a row of identifiers, from which the location and time of manufacture can be detected. Here, some bottles produced in Germany bear the glass mark of the glass works in which they were manufactured.

If low weight, low production costs or a specific chemical resistance play a part, it is in particular possible for plastic to be used as bottle material. In particular, bottles made of polyethylene terephthalate, polyethylene, polypropylene or polytetrafluoroethylene are used.

In a further aspect, the invention relates to cans, for example. Here, in particular both beverage cans and also food cans can be identified unambiguously by the preferred method. Besides bottles, beverage cans are the most important commercial packaging for beverages and, as a rule, serve as a drinking vessel at the same time. They are primarily used for beverages containing carbonic acid, such as canned beer and soft drinks, and are opened by means of pull tabs. Modern beverage cans comprise a one-piece cylindrical container made of aluminum, galvanized steel or tinplate and a seamed-on lid made of aluminum with an oval scored line and a riveted-on metal tab which, as an incorporated can opener, when lifted forces the scored oval into the interior of the can by means of a lever action and thus produces a pouring or drinking opening.

Beverage cans withstand an internal pressure of up to 6 bar and, as a result of the inwardly curved bottom, have a safety margin with regard to the volume. Before a beverage can bursts, the bottom curves outward and thus enlarges the volume of the can, which reduces the pressure. This curvature of the inner can bottom ensures that the can stands stably on an outer ring of the can bottom. This outer ring can be a structural element in the sense of the invention.

Typical foodstuffs made long-lasting by heating in food cans are fruit such as peaches, pears and pineapples, vegetables, in particular legumes such as cooked lentils and beans, fish such as sardines, mackerel and herring and corned beef, sausages, long-life bread and also ready-made meals with and without meat. In addition, powder, for example milk powder, is packed in food cans. In this case, before the closure a vacuum is produced in the can and nitrogen is then put in as a protective atmosphere in order to prevent spoilage of the content, since pasteurization is not possible in the case of powdery products. The common feature in all these products is that they can be spoiled particularly easily in raw form and can therefore be particularly reliably preserved by the method and system according to the invention.

For cans, deep-drawing or elongation is usually used as a preferred production method. There, a can is produced in simplified form from a circular piece of metal sheet in an elongating machine by means of mechanical shaping, and the can bottom is fabricated with a punch. For example, the structural elements can be produced with the aid of this punch. Furthermore, in this way the can bottom can be segmented, for example, and these segments can form a signature.

Since cans preferably consist of electrically conductive materials, such as aluminum, galvanized steel or tinplate, they trigger a touch event on a surface sensor when brought into contact with a surface sensor by a user or, if they are filled with liquid, in that the inherent capacity of the filled can is sufficient to trigger a touch event. Accordingly, the can can also be an empty can. Tinplate is a thin steel plate with a thickness of up to 0.49 mm, the surface of which is coated with tin by a hot-dipping method or electrolytically in order to protect the steel against corrosion.

A beverage carton is a disposable package made of composite materials for beverages and liquid foodstuffs. It comprises plastic-laminated board which, depending on the intended purpose, is coated on the inner side. Here, use is made of polyethylene, aluminum or EVOH (ethylene vinyl alcohol copolymers). The board imparts shape and stability to the composite material. The internal coating and—if present—the aluminum intermediate layer ensure the protection of the filling material. The outer coating protects the board against wetting through and increases the barrier characteristics of the composite.

According to the invention, such a disposable package is provided, for example without being restricted thereto, such that it has irregularities on one or more sides. These irregularities then constitute an evaluable data code in their form.

Furthermore, beverage cups can be detected capacitively by the method according to the invention. A beverage cup in the sense of the invention preferably designates a container for the preservation and for the transport of beverages, which can also serve as a drinking vessel. Normally, it has a shape tapering downward and is produced from plastic or paperboard. A purchaser frequently obtains a beverage in such a beverage cup for immediate consumption, where the beverage cup can be provided with a lid for protection against undesired spillage or to protect the beverage against contaminants. Beverages are usually sold in fast food restaurants, supermarket restaurants, shopping malls or furniture stores in beverage cups, which can be filled with a beverage by the purchaser himself at automatic self-service beverage machines. Here, a defined number of fillings of the beverage cup are included in the price.

A preferred application of the invention is then, when such a beverage cup is detected by the beverage output device and the renewed filling of the cup is either permitted or denied since, for example, the permitted number of fillings has already been reached. It may also be preferred for further filling no longer to be permitted following the expiry of a specific time interval after the first filling.

According to the invention, a container can, for example, also be a pack comprising a plurality of beverage containers if it has been assembled to form a pack by means of some packaging. One preferred example is a “six pack”, that is to say a pack which, for example, comprises 6 mineral water bottles or beer bottles and is preferably held together by plastic film or by a paperboard package and is transported therein.

In a preferred refinement of the invention, such a pack, which means the plastic film or the paperboard package, can also be provided with an information carrier.

In a further preferred refinement of the invention, the container has at least one customary bottom surface or side surface or a customary closure device, which is provided with structural elements.

In most bottles, the bottle bottom or the central bottle area is of such a nature as a result of the presence of structural elements that a characteristic pattern can be detected. These structural elements or the characteristic signature resulting therefrom can be detected by a surface sensor, the characteristic signature comprising regions of different capacitance being detected.

The bottom surface of one bottle type has, for example, a few relatively large elevations, on which the bottle stands stably. Other bottle types have many small elevations, which increase the friction with respect to the sub-base and are thus intended to stop the bottle slipping. These elevations or depressions are combined in the sense of the invention as structural elements. It was completely surprising that the capacitive surface sensor detects these structural elements of the bottom surface of the bottle as a signature comprising areas of different capacitance. Even closure devices can be carriers of structural elements. For instance, the lids of bottles often have grooves at the sides which, in the sense of this invention, can also be designated as structural elements.

According to the invention, however, the term “structural element” is intended also to be used for non-conductive, which means insulating, regions which cannot be detected by the capacitive surface sensor and thus produce a negative signature. These insulating regions can be implemented by insulating, that is to say electrically non-conductive, labels or specifically shaped insulating materials, which can be adhesively bonded, printed or fixed in any other way to the bottle bottom, to side surfaces or to the closure device. The use of negative signatures is particularly preferred in the case of flat bottles which have no pronounced physical structural elements. In a further preferred embodiment, these labels or materials do not have to be completely insulating; instead it is sufficient that the electrical properties differ so highly from the electrical properties of the container material that these differences can be detected and assigned unambiguously. Accordingly, even regions having an electrical conductivity that is increased in relation to the other container material can be structural elements.

Structural elements in the sense of the invention can also be regions of the bottle bottom, the bottle material of which has a thickness differing from the remaining bottom area. Since a greater material thickness is associated with lower capacitive coupling, in this way it is relatively simply possible to generate different capacitive signals, which lead to different characteristic signatures. This is advantageous, for example, when it is intended not to operate with structural elements that are turned to the outside, physical, visible and can be determined by touch.

In a further preferred refinement of the invention, bottles are selected from the group comprising glass bottles, plastic bottles, in particular PE, PP, PET or PTFE bottles, ceramic bottles, metal bottles or combinations thereof, and cans are selected from the group comprising food or beverage cans made of tinplate, steel and/or aluminum, where the steel can also be galvanized, for example. Therefore, the invention comprises a very wide selection of beverage containers and packages.

A further preferred embodiment of the invention is characterized in that there is touching contact between the container and a user and in that, as a result of this touching contact between the container and the user, a touch event is triggered. A user in the sense of the present invention is particularly preferably a human being, for example a purchaser, who obtains a beverage in a container according to the invention or a package according to the invention, or else a seller who wishes to provide information about the beverage. The human body has an electrical conductivity which brings about a capacitance change in the system comprising container and surface sensor when the user touches the container which is present and brought into contact with a surface sensor. This capacitance change is detected by the surface sensor as a touch event.

The human finger is conductive as a result of the electrical conductivity that is inherent in a human being and, as a result, is capable of bringing about a touch event. The touch point is likewise produced from an electrically conductive material, by means of which a touch event is brought about. Each touch point triggers a touch event. A plurality of touch points can together yield a data code or a characteristic signature, which can be detected by the surface sensor. Additional information can be stored in this data code. The touch points are connected to one another by conductive structures, where these structures are produced in the same manner as the touch points.

However, in the sense of this invention, the term “user” is to be interpreted more broadly and does not relate just to human beings. In a further aspect of the invention, users should also be beverage filling systems, such as in breweries, for example, automatic beverage sales devices, preferably automatic beverage machines, automatic receiving devices for emptied beverage containers, preferably return stations in supermarkets and discounters, or automatic beverage output devices in fast food restaurants, supermarket restaurants, shopping malls or furniture stores for the self-filling of beverage cups.

In the sense of the invention, the container can be provided with a solid, gaseous and/or liquid filling. For the case in which a liquid filling is involved, it is preferred that this filling be selected from the group comprising electrolytic liquids, polar liquids and/or liquids which have dipolar substances and/or ions.

Electrolyte designates a chemical compound which, in the solid, liquid or dissolved state, disassociates into ions which move in a manner directed under the influence of an electric field. Often, electrolyte also designates the solid or liquid material which contains the mobile ions. The electrical conductivity of such ion conductors is lower than is typical for metals; they are therefore designated as conductors of second class. However, further preferred contents can also be polar liquids or dipole-containing substances, water in the simplest case. De-ionized water, as is known, does not belong to the electrolytes but, on account of its dipolar character, is likewise suitable to trigger touch events on capacitive surface sensors or devices containing surface sensors.

The electrical conductivity of a liquid describes the sum of the substances dissolved in the water and is specified in the unit Siemens per centimeter. Substances which are typically present dissolved in water are alkali and alkaline earth ions, chloride, sulfate or hydrogen carbonate. The electrical conductivity of a liquid is a measure of the mineralization of the liquid. The higher a liquid is mineralized, the greater its electrical conductivity. Thus, mains water typically has an electrical conductivity of 500 to 1100 μS/cm, mineral water an electrical conductivity of 1200 to 8000 μS/cm, seawater an electrical conductivity of 42,000 to 55,000 μS/cm, and, for example, Coca-Cola of 1250 to 1300 μS/cm.

In the case of most bottles, the bottle bottom is of such a nature, as a result of the presence of structural elements, that a characteristic pattern can be detected. In a preferred embodiment, a user who is himself in touching contact with the bottle brings an electrically non-conductive bottle which is filled with an electrically conductive material into contact with a surface sensor. In the process, capacitive coupling, which triggers a touch event on the surface sensor, is produced through the bottle material via the electrically conductive liquid contained.

In a preferred embodiment of the invention, the surface sensor detects capacitance differences between different conductive liquids by using the differently intensely pronounced capacitive coupling between liquid and surface sensor. It was completely surprising that the surface sensor is capable for this purpose. This is implemented by different liquids bringing about coupling of different intensities between the surface sensor and the bottle.

In a preferred refinement of the invention, the surface sensor has means for determining the capacitance of a system comprising bottle and content at different frequencies. During the determination of the capacitance differences, the electrodes of the surface sensor form one or more capacitors, the charges of which are measured after specific time periods. These time periods depend on the frequency with which these capacitors are formed and the charges are then measured. In the process, the behavior of different materials differs at different frequencies. Therefore, firstly material determination is possible; secondly it is possible to optimize the detection by means of the specific selection of the material.

In a further preferred embodiment of the invention, bringing the surface sensor and the container into contact is implemented by the bottom surface and/or the closure device of the container. In the sense of the invention, bringing into contact means that there is preferably no clearance in particular between the bottom surface and/or the closure device of the container and the surface sensor. This means that the container is preferably in touching contact with the surface sensor. However, it may also be preferable for there to be no direct contact, instead even an approach is sufficient to trigger a touch event. In the case of an approach, between the container which is filled with an electrically conductive liquid and the surface sensor there is a preferred distance of 0 to 6 cm, particularly preferably from 0 to 4 cm, most preferably from 0 to 2 cm. The fact that such an approach between container and surface sensor is sufficient to identify the container or the content thereof unambiguously was completely surprising.

Such an approach is particularly advantageous in order to avoid contaminants, for example by liquids which, for example, can run out of an open bottle, on the surface sensor. Furthermore, the reading of the information stored on the container can be carried out more quickly as a result of approaching, for example on a conveyor belt in an automated plant. In addition, in the case of sensors in automatic beverage machines it is not always possible or desired to bring the sensor into direct contact with the container, since the latter has to be protected against moisture. Further application variants are also yielded by approaching, for example the information on a container can also be read through a pane of glass, for example in a display cabinet. Detecting an approach can also be used to trigger multi-stage actions. In this case, for example, an approach of the container to a surface sensor triggers action 1, whereas, for example, action 2 is triggered upon contact.

In a preferred embodiment, the invention relates to the triggering of at least one action in a device containing a surface sensor as a result of a touch event, and to the interpretation of the same. This can mean, for example, an acoustic signal, which sounds when the surface sensor detects a specific signature, brought about by the structural elements of the container. This opens up numerous areas of application of the invention. The method according to the invention can be used to make everyday life easier for human beings with restricted visual capability. For example, such a person can bring a bottle or a beverage can into contact with the surface sensor. Then, by using the structural elements on the bottom of the container and by using the capacitance data about the electrically conductive liquid in the interior of the container, the surface sensor detects which liquid is involved and, for example, can recite the name of the liquid by means of a speech output program. It is also possible, for example, for an information or dialogue monitor to be opened, without being restricted to these examples.

The interpretation of a touch event is the information-technical further processing of the data determined by the surface sensor. This data relates in particular to the capacitance of the electrically conductive liquid located in the container and the characteristic signature which is brought about by the structural elements of the container and which specifies the points on the surface sensor at which capacitive coupling takes place. In this case, the interpretation would then be, for example, the identification of the bottle currently located on the surface sensor and the content thereof as “naturally cloudy apple juice” from the manufacturer ABC, the bottle originating from the XYZ glassworks.

In a preferred embodiment of the invention, the action of bringing the surface sensor and the container into contact is implemented through the bottom surface of the container. Here, the container is preferably placed on the device having the surface sensor, so that physical contact is produced between the container and the surface sensor. However, it may also be preferable for this contact to be produced between the closure or a side surface of the container and the surface sensor. Here, both customary closures and side surfaces of containers can be detected by the surface sensor, or those closures or side surfaces which are provided with additional information carriers. It was completely surprising that the method according to the invention permits these degrees of freedom with respect to the configuration of the contact between container and surface sensor. Consequently, it is possible not only for the bottom surface of an electrically non-conductive container to be used for detection but instead the whole of the container. Not least, this fact permits, for example completely surprisingly, the integration of a plurality of structural elements or additional information carriers on a container or, for example but without being restricted thereto, a specific structuring of the bottom surface and structuring on the side of the container that can be differentiated from the former.

This configuration is particularly advantageous in order to take care of the sensitive surface of the surface sensor and preserve the same against damage.

In a further preferred embodiment of the invention, the device having the surface sensor has means in order to distinguish touch events brought about by the container from those touch events which are brought about by fingertips. Such means are known to those skilled in the art. This was a completely surprising effect of the method according to the invention. The characteristic signature of the container that is produced by the structural elements can be distinguished unambiguously from finger inputs with the aid of software and can be detected in an associated data-processing system in that, for example, “wobbling” touch points or varying touch point sizes are detected and interpreted appropriately or the capacitive signature is evaluated to this effect.

Here, distinguishing between a finger input and a container which is filled with a liquid can be implemented by the human body and the liquid container having different electrical conductivities. This difference results in a different capacitance, which is detected by the surface sensor. Furthermore, it is possible to detect the input by a finger from the fact that the finger always “wobbles” a little on the surface sensor, whereas the input by a container is constant. This wobbling can be detected by the surface sensor and assigned to a finger.

Furthermore, it is possible to detect the size of the touch event detected with regard to the diameter or the shape and thus to detect differing touch events. Moreover, the relative positions of individual touch events in relation to one another can be evaluated. The basis here is that fingers usually move relative to one another while touch points which are present in a manner attached to an information carrier do not move relative to one another and maintain fixed distances from one another.

It is known to a person skilled in the art that an input can be made on a touchscreen or a surface sensor by means of one or more fingers. These types of inputs are designated single-touch or multi-touch. The technology of surface sensors and the principles of the input, for example by means of which properties of a finger an input is made, are likewise known to those skilled in the art. For example, besides the electrical properties of the finger, that is to say the conductivity thereof, the pressure of the input or the contact area resulting therefrom, the distance from the surface sensor or inadvertently introduced material, such as contaminants, can influence the input. The preferred container achieves the same effect on a surface sensor as a finger as a result of its structural elements attached to its outer surface, namely an input at a position on the surface sensor that is defined by the structural elements of the container. Thus, without any great experimental outlay, the person skilled in the art could design the structural elements of the container in such a way that the properties of an input of a finger are simulated and, by using the structural elements, a signature is produced on the surface sensor.

In a further preferred embodiment of the method, the container can be provided with further capacitive information carriers. An information carrier in the sense of this invention can be, for example but without being restricted thereto, a label or a print in which additional information, for example relating to the container or the content thereof, can be stored.

In a preferred embodiment, additional information carriers or labels can be connected to the container, in particular by means of welding methods or adhesive bonding. A substantial advantage of this method is its simple handling and the possibility of individualizing the container. Depending on the material and the nature of the container material, it is possible to decide the way in which the additional information carriers are attached to the container.

Welding methods comprise, for example, ultrasonic welding, induction welding, radiation welding or further welding methods suitable for plastics. Ultrasonic welding is a method for joining thermoplastics and metallic materials. The necessary heat is achieved by means of a high-frequency mechanical vibration which is produced between the components by molecular and interface friction. Thus, ultrasonic welding belongs to the friction welding group. The vibrations are transferred under pressure to the workpieces to be connected, namely the container and the information carrier. They heat up and begin to soften, as a result of which the damping coefficient rises. The increase in the damping factor leads to higher internal friction, which accelerates the increase in temperature. The materials are in particular not heated as far as melting. The connection is produced following the rupture of the oxide layer substantially by means of intermeshing of the materials. The ultrasonic welding of the container and of the information carrier is characterized by very low welding times and high economy.

Of course, it may also be advantageous to fix the information carrier or label to the base object by means of adhesive bonding. It may also be particularly preferred to use electrically conductive adhesive in order to implement direct electric coupling. It is also possible to use a combination of electrically conductive and electrically non-conductive adhesives or to use what are known as “z-conductive” systems. In the last group, the conductivity is transmitted in only one direction (that of the z axis).

It may be advantageous to produce the information carrier or the label by means of an additive, semi-additive or subtractive method and/or to attach the same to the container. Furthermore, it is preferred for the information carrier to be produced by a printing method, preferably a mass printing method. Printing methods are sufficiently well known to those skilled in the art. However, it was entirely surprising that such an information carrier produced by the preferred method can be connected to the container.

The information carrier can advantageously be produced by means of additive methods such as printing methods, spraying methods, punching methods, PVD and CVD methods, galvanic methods or subtractive methods such as laser structuring, brushing methods, milling methods and the like. In addition, semi-additive methods, such as etching methods, may be advantageous. Of course, all other methods for producing an information carrier can also be used.

In particular, flexible and independent methods, such as the attachment of an additional information carrier by means of adhesives, permit completely surprisingly individual structures which can be interchanged and modified flexibly. Consequently, individual applications can be implemented readily, economically, quickly and flexibly.

The containers according to the invention are preferably produced by blow molding, blowing, vacuum or pressing methods, deep drawing, extending and/or a combination of these methods. The production method can be selected depending on the material of the container and of the desired content. In addition, during this selection, it is possible to take into account the extent to which the container is merely to be provided with customary structural elements or whether additional information carriers are to be attached to the container.

In a further preferred refinement, the device having the capacitive surface sensor has means for determining the location at which the touch event is triggered by bringing the container into contact with the surface sensor. In the sense of the invention, the term “location” is the location of the device having the surface sensor. The means which can be used to determine this location comprise, for example, location by the GPS system, which is a constituent of most devices having surface sensors. Further means for location determination by means of devices which have surface sensors are known to those skilled in the art. This refinement is primarily advantageous for marketing purposes for the producers of beverage products and their packages.

In a further preferred refinement, the invention relates to a system for the capacitive identification of a container which comprises an electrically conductive material or the content thereof comprising a device having a capacitive surface sensor and the container, the container being characterized in that at least one touch event is triggered when there is touching contact between the container and a surface sensor, the touch event being used for the identification of the container or the content thereof. Here, in particular the capacitance of the container and the content thereof is detected by the surface sensor and used for the purposes of the identification.

Here, it is a special benefit of the invention that the user can be a conventional consumer and the container can be customary bottles and beverage cans. Suitable devices which have surface sensors can be, for example, smart phones, cell phones, displays, tablet PCs, tablet notebooks, touchpad devices, graphics tablets, TVs, PDAs, MP3 players, trackpads and/or capacitive input devices and sensors, without being restricted thereto. The object of the invention is precisely to provide a system with which daily objects can be identified by a surface sensor.

By using the refinement according to the invention, a number of known disadvantages in the prior art are eliminated. These are, for example:
no additional production steps are needed in order to achieve a characteristic signature by means of structural elements on the container
no complicated structuring of electrically conductive layers
no physiologically dubious substances are used
structural elements can be produced in a great variety and can accordingly trigger a great variety of different touch events/touch event combinations

A further preferred embodiment of the invention consists in that the system comprising container and surface sensor is characterized in that the container has at least one bottom surface, a side surface, a closure device, a label, a hanging label and/or a package. In particular, these surfaces or devices or additional components of the container are then brought into contact with the surface sensor or approached thereto, by which means capacitive coupling between container and surface sensor takes place and a touch event is brought about.

The invention relates further to a use of the preferred method and/or the preferred system for the capacitive identification and distinguishing of electrically conductive liquids in a container. Here, the electrically conductive liquids to be distinguished can be all liquids which have variable properties which influence the electrical conductivity of the liquid and can thus be distinguished capacitively by a surface sensor. It is possible, for example, to distinguish: alcoholic or non-alcoholic beverages, original medical preparations or generics, original products or counterfeit products, juices, nectars or beverages containing fruit juice, beverages containing sugar or sugar substitutes, beverages with different fatty contents, lemonades or effervescents, mineral, mains, purified or distilled water and/or beverages or medicines which differ with respect to their concentration or active substance concentration.

In addition, by means of different electrical conductivities and capacitive coupling intensities, it is possible to distinguish whether the container has already been opened and content has been removed. Therefore, applications which inform the user, for example via speech output, to what extent the content of a container has been used up are conceivable.

In a further preferred refinement, the invention relates to the use of the method according to the invention or the system according to the invention for capacitively distinguishing electrically conductive liquids in a container. The preferred use is characterized in that the liquids have variable properties which influence the electrical conductivity of the liquid and thus a capacitance of the overall system comprising liquid and container and can thus be distinguished capacitively by a surface sensor.

Further advantageous measures are described in the remaining sub-claims; the invention will be described in more detail by using exemplary embodiments and the following figures.

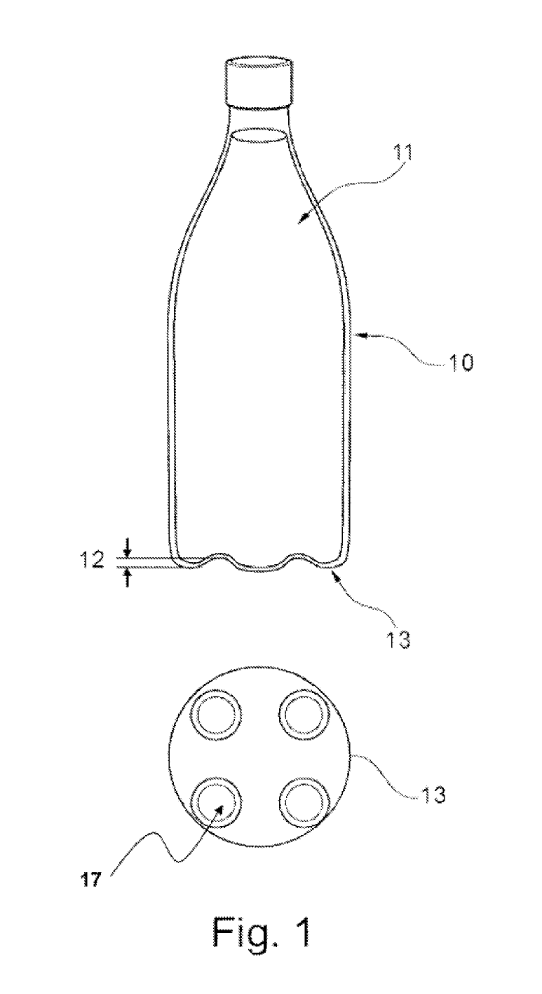

FIG. 1 shows a container (10) according to the invention, here a bottle, which is filled with an electrically conductive liquid (11). The bottle has a bottom surface (13) which is provided with structural elements (17). Structural elements according to the invention also comprise, for example, regions of different wall thickness (12) of the container material.

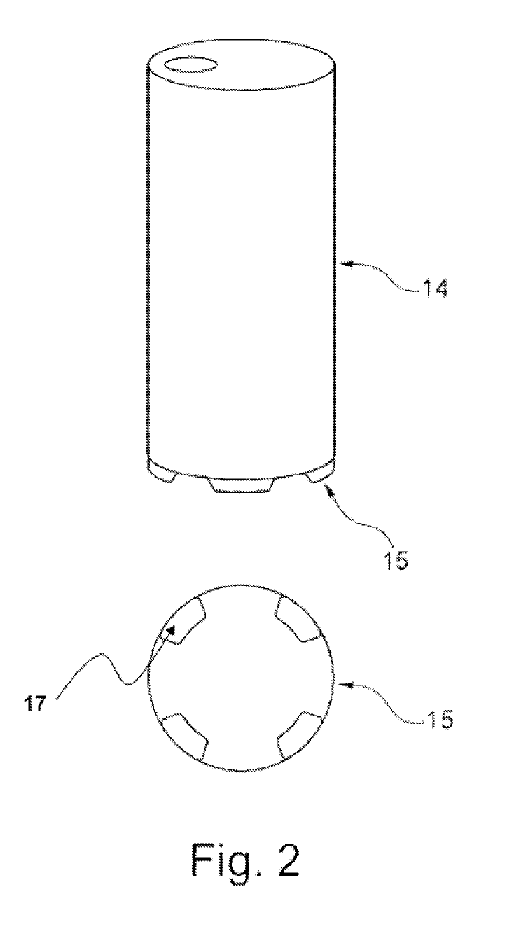

FIG. 2 shows a container (10) according to the invention, here a can. The can has a bottom surface (15) which is provided with structural elements (17).

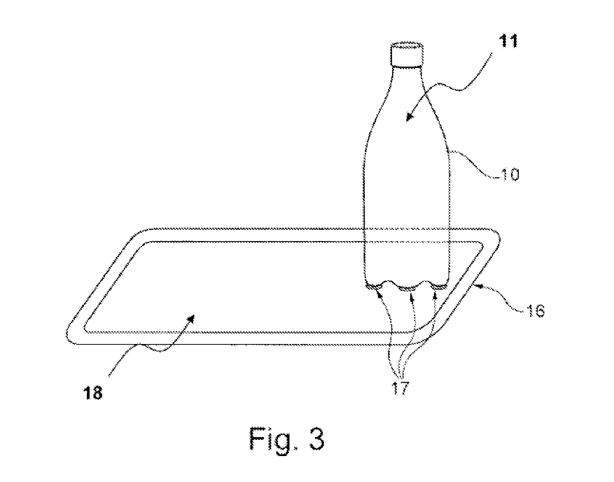

FIG. 3 shows a container (10) which is filled with an electrically conductive liquid (11), in this case a bottle, which is in contact with a device (16) which has a capacitive surface sensor (18). If a user then touches the container (10), capacitive coupling is produced between the container (10) and the electrically conductive content (11) thereof and the surface sensor (18). The intensity of this coupling can be detected by the surface sensor (18). Likewise, the device (16) having the surface sensor (18) detects the points on the surface sensor (18) at which capacitive coupling occurs. These points are determined by the structural elements (17) on the bottle bottom (13), which bring about a signature that is characteristic of the bottle type and which is detected by the device (16) having the surface sensor (18). In particular, the combination comprising the intensity of the capacitive coupling and the characteristic signature of the bottle bottom (13) permits identification of the container (10) and of the content (11) thereof.

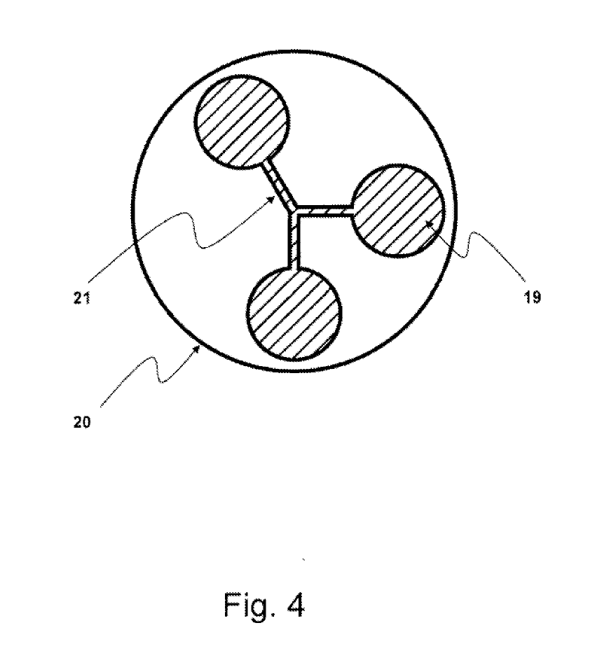

FIG. 4 shows an information carrier (20) having touch points (19) and conductive structures (21). The touch points (19) together yield a data code, which can be detected by the surface sensor (18). According to the invention, one such information carrier or a plurality of such information carriers can additionally be attached to the container, for example on or in a screw closure of a beverage bottle.

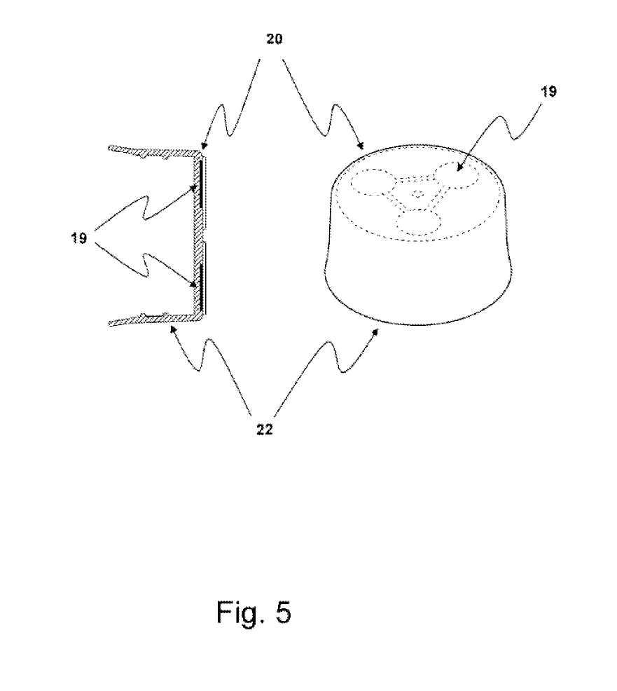

FIG. 5 shows the lid (22) of a bottle, which is provided with an information carrier (20). This information carrier (20) comprises a data code which consists of three touch points (19). The left-hand part of the figure shows a side view of the lid (22). This makes it clear that the information carrier (20) is attached to the surface of the lid (22) and contains the touch points (19).

FIG. 6 shows a further lid (22) of a bottle during a rotational movement (24). Here, the rotational movement (24) is brought about by a finger (23). However, it is also conceivable that the lid (22) is screwed onto the bottle and a user rotates the bottle which rests on the lid (22) on a surface sensor (18). The upper part of the figure shows a preferred embodiment of an information carrier (20), in which the touch points (19) are located at a defined radius around the center of the round lid (22), the touch points (19) having diameters of different sizes, since diameters of different sizes can be distinguished better from one another by the surface sensor (18).

### LIST OF DESIGNATIONS

10 Container
11 Electrically conductive liquid
12 Wall thickness of the container material
13 Bottom surface of the container, here a bottle
14 Container, here a beverage can
15 Bottom surface of a can
16 Device which has a surface sensor
17 Structural elements
18 Surface sensor
19 Touch point
20 Information carrier
21 Conductive structure
22 Lid of a bottle
23 Finger
24 Rotational movement

1. A method for the capacitive identification of a container which comprises an electrically conductive material, comprising the following steps
a. providing the container
b. providing at least one device having a capacitive surface sensor
c. bringing the capacitive surface sensor and the container into contact
d. at least one touch event being triggered on the capacitive surface sensor by capacitive coupling between the container and the surface sensor.

2. The method as claimed in claim 1,
characterized in that
the electrically conductive material is selected from the group comprising a filling of the container, a material of the container and/or a constituent of an information carrier on or in the container.

3. The method as claimed in claim 1,
characterized in that
the filling of the container is solid, gaseous and/or liquid.

4. The method as claimed in claim 2,
characterized in that
one or more information carriers are present in a bottom, in a closure device, in a label, in a hanging label, in a package, in and/or on a side surface of the container.

5. The method as claimed in one or more of the preceding claims,
characterized in that
the container is selected from the group comprising bottles, cans, beverage cups or beverage cartons.

6. The method as claimed in one or more of the preceding claims,
characterized in that
the container has at least one customary bottom surface and/or side surface and/or a closure device, which have structural elements.

7. The method as claimed in the preceding claim,
characterized in that
the structural elements are indentations, depressions and/or grooves.

8. The method as claimed in one or more of the preceding claims,
characterized in that
the structural elements are selected from the group comprising labels with a higher or lower capacitance than the container material and/or regions which have a greater or smaller wall thickness than the rest of the container.

9. The method as claimed in one or more of the preceding claims,
characterized in that
bottles are selected from the group comprising glass bottles, plastic bottles, in particular PE, PP, PET or PTFE bottles, ceramic bottles, metal bottles or combinations thereof and cans are selected from the group comprising food or beverage cans made of tinplate, steel and/or aluminum.

10. The method as claimed in one or more of the preceding claims,
characterized in that
there is touching contact between the container and a user.

11. The method as claimed in one or more of the preceding claims,
characterized in that
the liquid filling of the container is selected from the group comprising electrolytic liquids, polar liquids and/or liquids which have dipolar substances and/or ions.

12. The method as claimed in one or more of the preceding claims,
characterized in that
bringing the surface sensor and the container into contact is implemented by bringing the bottom surface and/or the closure device of the container into contact with the surface sensor.

13. The method as claimed in one or more of the preceding claims,
characterized in that
the device having the capacitive surface sensor has means in order to distinguish the touch event produced by the container from those touch events which are produced by a fingertip.

14. The method as claimed in one or more of the preceding claims,
characterized in that
the container which is filled with an electrically conductive fluid is produced by blow molding, blowing, vacuum or pressing methods, deep drawing, extending and/or a combination of these methods.

15. The method as claimed in one or more of the preceding claims,
characterized in that
the device having the capacitive surface sensor has means for determining the location at which the touch event is triggered.

16. A system for the capacitive identification of a container or the content thereof which comprises an electrically conductive material, comprising a device having a capacitive surface sensor and the container,
characterized in that
at least one touch event is triggered when there is contact between the container and a surface sensor, the touch event being used for the identification of the container or the content thereof.

17. A system for the capacitive identification of a container or the content thereof which comprises an electrically conductive material, comprising a device having a capacitive surface sensor and the container,
characterized in that
the container has at least one bottom surface, a side surface, a closure device, a label, a hanging label and/or a package.

18. Use of the method as claimed in claims 1-15 and/or of the system as claimed in claim 16 or 17 for the capacitive identification of an electrically conductive material in a container.

19. Use for capacitively distinguishing electrically conductive liquids in a container,
characterized in that
the liquids have variable properties which influence the electrical conductivity of the liquid and thus the capacitance of the overall system comprising liquid and container and can thus be distinguished capacitively by a surface sensor.
